(19) United States
(12) Patent Application Publication
(10) Pub. No.: US 2024/0092406 A1
(43) Pub. Date: Mar. 21, 2024

(54) Method to Manage Autonomous Vehicle Energy

(71) Applicant: Matthew Younkins, Los Gatos, CA (US)

(72) Inventor: Matthew Younkins, Los Gatos, CA (US)

(21) Appl. No.: 17/933,038

(22) Filed: Sep. 16, 2022

(51) Int. Cl. B61L 27/04; B60L 53/10

(52) U.S. Cl. CPC B61L 27/04; B60L 53/10; B61L 2201/00

(57) ABSTRACT

Method to improve the capability of electric transport, particularly autonomous electric transport, by dynamically reconfiguring a group of vehicles, connecting or disconnecting railcars to manage total energy available while motion continues. Vehicles connected while in motion can transfer energy to or from the train with railcars equipped with traction motors that can deliver energy to a train without delaying other cars. Railcars with low state of charge can be recharged by other railcars in the train or can disengage to be re-routed and re-charged en-route.

### CROSS-REFERENCE TO RELATED APPLICATIONS

The invention of the present application claims priority based on U.S. Provisional Application Ser. No. 63/245,197, filed on Sep. 17, 2021, the entire disclosure of which is incorporated herein by reference).

### PRIOR ART

U.S. Pat. No. 6,308,639 B1 describes a yard switcher equipped with a gas turbine generator to generate electricity in conjunction with a battery storage system in a fuel-efficient manner. The gas turbine effectively operates as a series hybrid generator to charge a large capacity electric power and also provides locomotive power to the system.

U.S. Pat. No. 6,555,991 B1 describes a method to control energy transfer between an energy bus and a battery system. A controller reacts to extreme voltage in the battery and responds to extreme voltage by changing the energy transfer between the energy bus and battery system.

U.S. Pat. No. 8,640,629 B2 describes battery powered electric locomotive and train configurations. In one case, a locomotive is driven by traction motors with energy supplied by a battery. The battery management system controls the batteries to optimize state of charge and depth of discharge. Regenerative brakes are prioritized over an air braking system to optimize energy capture during braking. A battery-toting locomotive can be positioned between two diesel-electric locomotives, with the batteries able to recover energy from regenerative braking and can in turn supply power to drive traction motors.

U.S. Pat. No. 9,517,780 B2 describes a system to control speed in rail vehicles. The system estimates future speed and determines the inputs required for the powertrain to achieve appropriate train speed. The appropriate train speed can be determined or limited by a number of different factors that were described, including Time-To-Speed-Limit Crossing, an Automatic Train Protection, or other parameters.

U.S. Pat. No. 9,975,435 B2 describes a device, consisting of at least one gas driven electric power generator, that can supply energy to a train by using an engine or fuel cell. The device supplies a train with electrical current supply during, for instance, idle operation.

U.S. Ser. No. 10/262,542 B2 details a control system to determine how two vehicles traveling towards a common location and determine whether vehicles can be joined into convoys. The description details a method to direct a portion of the vehicles in the convoy to separate from the convoy, or alternatively, to join the convoy of vehicles.

U.S. Ser. No. 10/854,089 B2 describes a method for coordinating a group of autonomous vehicles into a platoon of vehicles. A coupling inquiry is sent to other vehicles nearby to form or join a vehicle group, and checks whether conflicts may exist or have been resolved.

U.S. Ser. No. 10/858,017 B2 describes a method to control the acceleration of a vehicle to soft-land at a target destination. The method selects from a series of system states of the vehicle, and selects one possibility that the algorithm has determined follows a path of reachable conditions, and then controls the vehicle to reach the destination based on those determined states.

U.S. Ser. No. 10/899,323 B2 describes some systems and methods to coordinate and control vehicles to form a platoon. On board controllers react to vehicle sensors to monitor and control the vehicle order and paths traveled, and take into consideration gross vehicle weight, axle loads, and stopping distance of each vehicle. Individual vehicle characteristics are taken into account to be able to order the vehicles in a platoon to minimize distance between vehicles while maintaining adequate follow distance to ensure no collisions will occur.

U.S. Ser. No. 10/977,874 B2 describes a method to interpret data from vehicle sensors from a variety of different vehicles. It compares sensor data from multiple vehicles and identifies the relationships between each vehicle and the sensor data from each. One potential outcome based on the details from the vehicles and sensors is alerting occupants of a vehicle of potential anomalies.

U.S. Ser. No. 11/325,624 B2 describes a rail drone, which consists of a payload interface, a powertrain, and a rail platform. These rail drones can be combined and interact to autonomously transport cargo on rail.

US 2002174796 describes an energy tender vehicle to be used with a train that has an energy storage and regeneration system that captures braking energy of the train. The battery or alternative means of storing energy is located in an energy tender vehicle. The tender vehicle can be equipped with traction motors, and can operate without power connections to the locomotive. The energy management system considers the energy storage capability in both capacity and throughput, and includes as part of the determination of present and future track profile information.

US 20040056182 A1 describes the use of scanning laser beam to detect obstacles on or near railways. A laser is projected beyond the train, and sensors detect reflections of the laser from the object. A processing device and algorithms then determine distances to objects and determine whether a collision is imminent.

US 20050107954 A1A describes a navigation unit that uses GPS to spatially locate a train, and then communicates using a transponder to other transponders in order to determine if collision risks exist within a database of possible other trains or other devices.

US 20060005738 A1 describes a railroad vehicle that includes a traction motor capable of power regeneration and an electrical energy storage system among other components. In the regeneration mode, kinetic or potential energy is converted to electrical energy by the traction motor and is stored in the energy storage system. A controller issues commands to optimally operate the devices and transmit them to appropriate other devices.

US 20070272116 A1 describes a method of assisting electric locomotives and energy storage cars to assist uphill climbs. The train can add locomotives and energy storage cars prior to the uphill climbs, and/or can use those electric locomotives and energy storage cars to store regenerated electric energy during downhill operation.

US 20080021602 A1 details how to operate an electric rail continuously while dealing with external power supply lines that are in practice not continuous. An electrically powered rail powertrain is able to operate continuously despite breaks in the supplied electric power with an ultracapacitor pack that supplies power during intermittent breaks in electric power from an external supply of electricity.

US 2008223250 describes a train set that uses regenerative braking power during braking and captures that energy. The stored energy is used to supply energy continuously to power demands on board the train. This method largely avoids operating any supplemental energy system production during periods of time in which the primary locomotive power generation systems are not operational.

US 20140218482 A1 describes a method to use cameras to allow autonomous or driver-assistance systems that use a combination of cameras to recognize obstructions or obstacles and determine the location of the obstacles, and the velocity and acceleration of those objects if they are in motion. This allows for a control system to brake the train prior to a collision.

US 20190179335 A1 describes a platoon of hybrid electric vehicles, in which vehicle speed and acceleration of each vehicle is communicated in order to better synchronize the platoon of vehicles to operate under a pulse-and-glide traveling mode. The order of vehicles in a platoon is based on the acceleration information, and the time and phasing of the glide phase is determined based on the information about other vehicles in the platoon.

US 20200264634 A1 describes a method of controlling vehicles including linking vehicles to form a platoon. A handoff control module determines lead vehicle and lag vehicles, and the method of operation of the lag vehicle is determined in part by the operation of the lead vehicle. After an interval of time, the handoff control module can reassign the role of lead vehicle to a different vehicle and the vehicles are re-ordered.

WO 2020114659 A1 describes an invention that has various energy systems, where a locomotive is augmented by trolleys that have further energy supply systems. Energy supply systems can be distributed between the locomotive car and trolley vehicles. Propulsion can be via a variety of different motors or diesel engines that generate electric power.

DE 102012021282 A1 describes a method to control an automated motor vehicle, and details the method to determine the path of the vehicle with input from sensors to control the planned path of the vehicle. The invention then transfers data detailing the trajectory of the vehicle through a communication link between vehicles, and checks for spatial conflicts and takes necessary steps to avoid collisions.

### BACKGROUND OF THE INVENTION

The environmental impact of transportation has motivated improvements in transportation efficiency. Rail transportation is inherently more 3-4× more cost and fuel efficient than truck transportation of vehicles, but delays in transport and access to rail precludes some portion of cargo transport from being carried by rail. Moreover, the infrastructure costs of trucking are borne by the public; most of the vehicular damage done to highways is inflicted by truck freight, and fuel taxes only cover a small portion of the damage that needs to be repaired annually. Conversely, the infrastructure costs of rail transport is generally the responsibility of the rail operators.

The US Department of Transportation's Bureau of Transportation Statistics (BTS) indicated that in 2018, approximately 39.5% of freight ton-mileage was transported via heavy duty truck. Other than air freight, which is used for only 0.2% of total freight transport in the United States, trucking is both the least fuel-efficient method and the most expensive method. Truck transport has the advantage of being convenient as nearly every home and business in the contiguous United States is served by the public system of road transportation. Truck freight is the most expensive option of transport but is generally the only option that directly serves both the origination and destination of either freight or passengers. Moreover, the costs of trucking are not fully borne by the transporter, as the road system is not funded fully by users via tolls, vehicle taxes, and fuel taxes; currently nearly half of the infrastructure costs of the road system are funded from general revenue sources.

Trucking also generates large amounts of toxic emissions and greenhouse gas emissions. Truck transportation is largely powered by diesel combustion, which spreads large amounts of toxic oxides of nitrogen and particulate matter into the atmosphere. In 2019, the European Heart Journal published an article by Lelieveld et al. that concluded that 15 to 28% of the 1,850,000 cardiovascular disease fatalities annually in the EU-28 were due to air pollution. In 2018, the International Energy Agency indicated that 11% of greenhouse gas emissions worldwide were incurred due to freight transportation. In the U.S., truck transportation is both the largest single mover of freight and the least efficient means of moving freight.

In order to combine the cost and efficiency advantages of rail transport with the widespread access advantages of the road system, a combination of rail and truck transport is often used, and is termed ‘intermodal’ by the industry. This involves, in a common example, freight moving some distance by truck, to a railroad terminal, where it is transferred to a railcar to a convenient railroad terminal, where it is then transferred to a truck again for delivery to the end location. This example of truck, to train, to truck again, is a common example of intermodal travel but many other combinations exist, in a variety of sequences. These intermodal methods take advantage of the reduced cost and reduced fuel usage of more efficient freight transfer methods, but with the added inefficiency and delay of transferring the freight from one mode of transportation to another mode of transportation. These transfer delays and inefficiencies reduce the opportunities available to commonly use intermodal transportation of freight. The BTS reported that in 2018 the overall ton-miles of freight being transported intermodal was only 7.6% of the total ton-mileage in the United States.

In order to improve the throughput of vehicle freight, many companies are currently working on trucks and locomotives to create autonomous vehicles that are capable of full self driving in all or nearly all conditions. The widely varying conditions encountered on public streets are challenging compared to the more limited conditions and traffic encountered on railroads, however, no fully autonomous truck or railroad vehicle has been widely released to date, even though the introduction of those vehicles has been anticipated for many years.

Personal transportation in the United States is dominated by personal vehicles, usually cars and light duty trucks. The BTS reported that in 2020, cars and light duty trucks comprise about 84% of total passenger mileage in the US, with airplane travel (5.8%), bus travel (5.8%) and combination tractor-trailer travel (3.4%) accounting for most of the remaining transportation. Rail travel is currently only used for approximately 0.4% of passenger-miles traveled in the United States. Most cars and light duty trucks both worldwide and in the United States propulsion generated from fossil fuel combustion. Electric vehicles are a growing part of the market, but electric vehicle usage is sometimes limited by the limited range of electric vehicles, which in turn is limited by the large mass and size of electric vehicle batteries. Electric fast charging in practice is presently limited to about 50 to 400 kilowatts (kW), with individual cars sometimes restricting that rate further due to power electronics limitations and/or battery durability concerns. As charging at these rates in practice damages expensive vehicle batteries, fast charging is often limited to a small portion of the charge range where the damage done to the battery is minimized. In contrast, gasoline pumps in the United States are limited to 10 gallons of fuel per minute, which corresponds to an energy refueling rate of about 20,000 kilowatts. This enormous discrepancy drives large differences in refueling/recharging times and often drives users to adopt gasoline vehicles in order to accommodate situations when large distances are intended to be traveled without incurring long periods of times where the vehicle must be stopped to recharge.

Other limitations to widespread adoptions of rail transport are the queueing times for an appropriate amount of railcars or passengers to be assembled, logistical delays and difficulties in getting from the origination location to the railroad and from the railroad to the final destination, delays en-route due to waiting for other traffic on the railroad, or waiting for other modes of travel of at-grade intersections, among other limitations.

### SUMMARY OF THE INVENTION

The present invention relates generally to electric or hybrid vehicles, including vehicles that travel on railroads, and the efficient operation including integrating a means of charging a vehicle while it is en route to a destination by an adjacent vehicle, capable of being piloted completely autonomously or partially assisted by control algorithms to allow close operation or linked operation of the system. The vehicles, if they are partially or fully driven by energy stored electrically, can be charged by electricity made available by one or more powertrains capable of generating electricity or from electricity stored onboard one or more vehicles, so that when the vehicle being charge reaches a destination or convenient point, the vehicle charging will be substantially charged. To enhance the ability of the system and overall throughput, electricity can be balanced between vehicles, battery tenders, and items being transported in order to optimize the charge or range of vehicles and items being transported, and control the state of charge of each electric battery appropriately.

In this invention, a vehicle is taken to include devices used to transport people or goods. Most embodiments discussed herein use as examples vehicles designed to operate either in part or exclusively on railroads, as the execution of the methods described are perhaps easiest to realize in practice in that environment. This example embodiment does not exclude the method from being used in alternate environments, including on common roads, or other systems of transportation, including transportation via air or water.

The present application is directed towards improving the spatial, time, and energy efficiency of transportation. Advances in autonomous operation of vehicles allow for vehicles originating from disparate original locations to come together and operate at high speed in close proximity or in connection to one another with little or no human intervention required. At operating speed, a set of one or more vehicles can be connected physically or wirelessly to an adjacent set of one or more vehicles, with connections being created automatically or substantially assisted as required. Overall transportation throughput is maximized both for the rail by dynamically reconfiguring vehicles, but also for other modes of traffic as well by transporting and charging electric vehicles designed for road use, and intermittently pausing rail traffic to the extent of splitting a train into two groups of cars so cross traffic can pass. Depending on the energy requirements of each of the vehicles and the energy predicted to be required to reach a position en route convenient to recharge the vehicle or transfer further energy to the vehicle, the energy distribution for each vehicle can be optimized so that the overall outcome of all vehicles is optimized. This method of energy balancing system can take into account the urgency of each vehicle in terms of reaching a destination. The electric energy can be sourced in part from overhead lines designed for that purpose, or from energy stored or generated in or on cars.

### BRIEF DESCRIPTION OF DRAWINGS

The invention and the advantages thereof, may best be understood by reference to the following description taken in conjunction with the accompanying drawings in which:

FIG. 1: Inserting an additional railcar from a separate second track into a train of railroad cars, with three timesteps shown.

FIG. 2: A railcar disengaging from a train of railcars, with three timesteps shown.

FIG. 3: Inserting an additional railcar transporting some portion of energy to transfer into the train, where the railcar is coming from a second track, with three timesteps shown.

FIG. 4: A railcar, where a portion of the objects being carried consist of an energy storage system where the energy has been transferred to other railcars, including locomotives, autonomously disengaging from a train of railcars, with three timesteps shown.

FIG. 5: Showing a variety of methods of energy transfer between energy storage and generation mechanism on or being carried by a train, and also showing an indicative energy transfer method from an external power source.

FIG. 6: Shows a top down view of a series of railcar intermittently stopping in order to facilitate cross traffic to pass such that the train minimally impedes other traffic.

FIG. 7: Shows an energy storage railcar connecting with a second group of railcars, with the energy storage railcar designed in a manner such that operation of the both sets of railcars are not constrained, with four timesteps shown.

### DETAILED DESCRIPTION OF THE INVENTION

A series of vehicles, in some embodiments consisting of railroad cars, has some or all railcars equipped with their own source of propulsive power, and can be controlled autonomously, piloted by a driver, or controlled externally through wired or wireless communication to the railroad train or some other external source of control. The railcars can separate and re-connect regardless of the speed of the train, which allows both dynamic entry of a railcar into the train and dynamic egress of a railcar from the train. This allows railcars with disparate points of origin and disparate destinations to benefit from the energy efficiencies of the train and the improved usage of the railroad tracks.

In order to increase the utilization of embodiments that include the use of railroads, freight may be carried by trucks, or trucks that can be converted to railroad cars through use of railroad wheels that are either fixed and out of the way of road wheels, or railroad wheels that can move into position when the vehicle transitions from road to rail or rail to road. Similarly, the road wheels can either be fixed or can move out of the way when transitioning from road to rail or from rail to road.

In order to increase the utilization of embodiments that transfer freight or passengers from one mode of transportation to a different mode of transportation, this intermodal transport may be assisted through attaching or detaching components that allow railcars on the train to transfer mechanical, electrical, pneumatic, hydraulic, or other energy throughout the train. This energy can potentially include power for propulsion, be it the tension of pulling a mechanical coupling, or electrically transmitting power directly or indirectly to powered wheels on the railcar or other railcars, or by other means of energy conveyance.

For passenger travel, passengers can load onto individual modules, vehicles, or groups of vehicles at places of convenience, for example, train stations designed for that purpose. These vehicles may have the destination of the individual vehicles, for example railcars, predetermined and broadcasted for public knowledge. In an embodiment consisting of railcars, when a railcar connects with a train, passengers may be able to transfer to different railcars to allow for travel to alternate destinations. The state of charge of each railcar will be balanced based on the state of charge estimated to be required to reach the final destination, and during the period for which it is relevant, the energy would be balanced appropriately among railcars. At convenient points, railcars would detach from the train and travel to the correct destination. Some railcars may have as their exclusive purpose the transfer of energy from convenient charging locations to other cars in motion.

In some embodiments, vehicles can be loaded as freight on railcars designated or built for that purpose. At convenient locations, a vehicle, for example a passenger car designed for use on public roads, can be loaded onto a railcar alone or in conjunction with other cars. Methods can be used to determine destination, routes, and fueling or charging to be conducted en-route, for example, by using a software application designed expressly for that purpose, such that the vehicle being transported is substantially recharged enroute to the point where it is unloaded from the railcar transporting it. In an alternative embodiment, a set of one or more passenger cars may be simultaneously transported and charged by a freight truck designed for that purpose. A separate passenger area may be employed by the transporting vehicle in order to transport passengers and passenger vehicles simultaneously.

When convenient, vehicles that require additional electric energy or other energy or fuel may detach from the group of other vehicles to receive additional energy or fuel, such as at a dedicated recharging station built for that purpose. In some embodiments, individual vehicles may have as their primary purpose the transfer of energy to other vehicles traveling.

In one embodiment, some or all of the energy used to transfer to vehicles transported can be transferred from the railroad cars themselves to devices onboard; for example, an electric passenger vehicle being conveyed by the railroad car can be charged by the railroad car.

In one embodiment, some of all of the energy can also be transmitted by completing a circuit with stationary static sources, the circuit being completed dynamically, longitudinally along the direction of travel, avoiding the hazards of having ground-level circuits available with contacts in close proximity to each other. Instead, two contacts can be used that are far enough apart to reduce or eliminate the chance of short-circuit. A forward rail connection can make a connection with one contact, while a trailing connection makes another contact. Those connections could be as close as neighboring rail wheels, if the electrical connection is via wheels, or perhaps as close as three feet apart or closer, if connections other than through wheels are used. The connections could be potentially one or many cars apart, connected via an electrical connection between the cars and any intermediately apart. Furthermore, the contacts could be energized at all times or alternatively could be energized only when in contact with the appropriate wheels, and that connection could be energized through a management system that synchronizes energy and polarity of connections. Wireless communications, proximity sensors, railroad schedules, and other means of ensuring safety and efficient electrical connection can be used to manage the electrical transfer.

Freight may be transferred from road going conveyance to rail based conveyance via containers made expressly to be able to be transferred from one conveyance to another. This transfer can be done by human operators, or it can be automated, reducing or eliminating delays and energy spent dealing with intermodal freight inefficiencies.

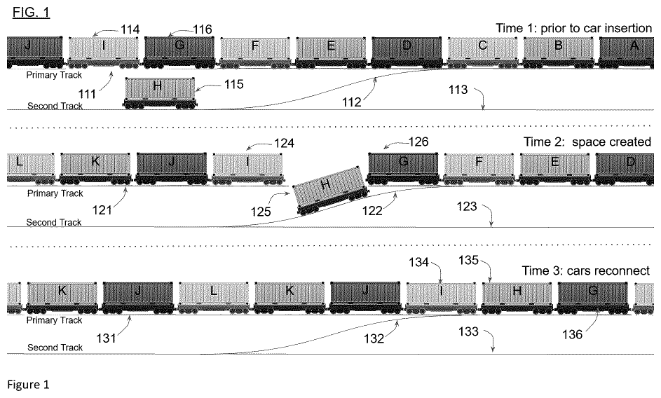

Reference is now to FIG. 1 showing three timesteps, separated by dotted lines, of a train of railcars operating according to one embodiment of this invention.

In the first timestep shown in FIG. 1, one or more cars, on railtrack 111, will be dynamically linked to a second group of one or more cars 115 on track 113 via a joining track 112. Although the embodiment shown shows the second group of one or more cars on a separate second track, all of the embodiments of this invention may have the second group of cars joining the first group of cars on a single track with the limitation that the cars be connected front to back. At least one of the cars being represented by the single car 115 is capable of providing propulsive force through energy storage and motors designed for that purpose, and is outfitted with systems to allow autonomous operation and allow or require communication to nearby vehicles and track control devices such as rail switches. Switches are controlled to allow railcar 115 to be inserted between railcars shown here as 114 and 116. In FIG. 1, all railcars are shown transporting modular containers to ease shipping transfers between different modes of transport, commonly known as ‘shipping containers’, but alternative embodiments of the invention can use railcars mixing conventional rail ‘boxcars’, railcars designed to facilitate the ease of transferring shipping containers, or any other railcar or relevant vehicle.

In the second timestep shown in FIG. 1, showing the same train of railcars in which one or more cars, on railtrack labeled by 121, have disconnected into two groups of trains. Both the group of railcars including railcar 124 and the group of railcars including railcar 126 included vehicles capable of providing total propulsive force required. The velocity of the group of railcars including railcar 124 and the group of railcars including railcar 126 are controlled such that an appropriate gap is opened both spatially and temporally to allow a railcar, here shown as railcar 125 to use track 122 to move to track 121. The three groups of railcars sense or communicate position, velocity, acceleration, and distances to ensure adequate operation of each vehicle is maintained and will continue to be maintained. In embodiments where two groups of cars are connecting front to back, either on two sets of tracks or on the same track, this process of separating the first group of railcars into two groups of railcars is not necessary.

In the third timestep shown in FIG. 1, showing on the same railtrack labeled 131 the same railcars having reconnected into one interconnected train of railcars. Railcar 135 has exited tracks 133 and 132 and closed the gap to railcar 136 and has reconnected mechanically and, in some embodiments, electrically, to car 136. Similarly, railcar 134 has closed the gap to railcar 135, and also has reconnected all appropriate connections, including all mechanical, electrical, pneumatic, hydraulic, and potentially other connections. The electrical connections can have several embodiments themselves but the preferred embodiment allows state of charge balancing between batteries, preferentially charging batteries for groups of railcars that will be traveling to locations that require higher amounts of energy to get to their destination.

Reference is now to FIG. 2 showing three timesteps, separated by dotted lines, of a train of railcars operating according to one embodiment of this invention.

In the first timestep shown in FIG. 2, a train of railcars are shown on railtrack labeled 211 at time 1, prior to railcar 215 disconnecting from cars 214 and 216 and a switch not pictured will transfer car 215 to an alternate track 212 that in one embodiment leads to a second track 213.

In the second timestep shown in FIG. 2, the same train of railcars on the same railtrack now labeled 221 at time 2, after the railcar labeled as 225 has disconnected all mechanical, electrical, pneumatic, hydraulic, and other connections from cars 224 and 226. The disconnection time and the speeds of all sets of railcars are controlled to allow gaps to open up to allow railroad track switches enough time to operate correctly, and those gaps are based on velocities and time required for switches to operate. The travel has been switched to track 222 and the railcar will in the embodiment shown lead on to track 223.

In the third timestep shown in FIG. 2, the disengagement of the railcar is complete. The disengaged railcar, now labeled 235 has used track 232 to transfer to track 233. The remaining railcars are still on track 231 as the switch has returned to the original position and the remaining cars continue on track 231, bypassing track 232. Railcars 234 has reconnected to railcar 236 and all appropriate connections, electrical, mechanical, hydraulic, pneumatic, have been reconnected.

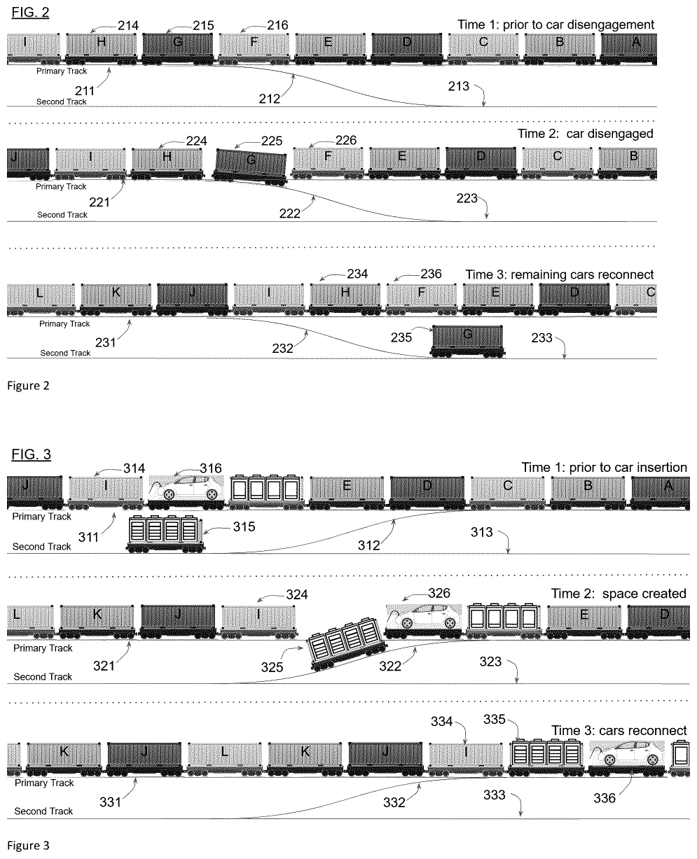

Reference is now to FIG. 3 showing three timesteps, separated by dotted lines, of a train of railcars operating according to one embodiment of this invention.

In the first timestep shown in FIG. 3, similar to the first timestep of FIG. 1, a train of railcars is shown in which one or more cars, on railtrack 311, will be dynamically linked to a second group of one or more railcars 315, having an appreciable amount of energy stored on the railcar and intended to be transferred in whole or part to other energy storage or energy using devices elsewhere on the train. Railcar 315 is on track 313 via a joining track 312. The car 315 is to be inserted between cars 314 and 316, but in other embodiments will connect to either the front of the train or the rear of the train.

In the second timestep shown in FIG. 3, similar to the second timestep of FIG. 1, the same train of railcars from the first timestep is shown, in which one or more cars, on railtrack labeled 321, have disconnected into two groups of trains. The railcar transporting energy, labeled 325, has left the second track 323 and is using track 322 to move to track 321. The railcar is maneuvering and controlling both position and velocity to be able to connect to both railcars 324 and 326. Similar to earlier descriptions, in embodiments where two groups of cars are connecting front to back, either on two sets of tracks or on the same track, this process of separating the first group of railcars into two groups of railcars is not necessary.

In the third timestep shown in FIG. 3, similar to the third timestep of FIG. 1, the same train of railcars from the first and second timesteps is shown, and the train of railcars on railtrack labeled 331 has reconnected into one train of railcars. The railcar containing energy for transfer to other portions of the train, 335 has exited tracks 333 and 332 and closed the gap to railcar 336 and has reconnected all appropriate connections, including all electrical, mechanical, hydraulic, pneumatic and other connections to car 336. Similarly, railcar 334 has closed the gap to railcar 335, and also has reconnected all appropriate connections, including all mechanical, electrical, pneumatic, hydraulic, and potentially other connections. The electrical connections can have several embodiments themselves but the preferred embodiment allows state of charge balancing between batteries, preferentially charging batteries for groups of railcars that will be traveling to locations that require higher amounts of energy to get to their destination.

Reference is now to FIG. 4 showing three timesteps, separated by dotted lines, of a train of railcars operating according to one embodiment of this invention.

In the first timestep shown in FIG. 4, similar to the first timestep of FIG. 2, a train of railcars on railtrack 411 is shown at time 1, prior to railcar 415, which in this embodiment has been discharged and has used that energy to recharge or power other railcars and sources of propulsion distributed or concentrated in the train. Railcar 415 will disconnect from railcars 414 and 416, and controls will control the velocities of each group of vehicles to allow gaps to form to in turn allow enough time between cars pass to allow a switch not pictured to transfer car 415 to an alternate track 412 that in one embodiment leads to a second track 413.

In the second timestep shown in FIG. 4, similar to the second timestep of FIG. 2, the same train of railcars is shown on same railtrack now labeled 421 at time 2, after railcar 425 has disconnected all mechanical, electrical, pneumatic, hydraulic, and other connections from cars 424 and 426. The disconnection time and the speeds of all sets of railcars are controlled to allow gaps to open up to allow railroad track switches enough time to operate correctly, and those gaps are based on velocities and time required for switches to operate. The travel has been switched to track 422 and the railcar will in the embodiment shown lead on to track 423.

In the third timestep shown in FIG. 4, similar to the third timestep of FIG. 2, the same train of railcars is shown, and the disengagement at time 3 is now complete. The disengaged railcar 435 has used track 432 to transfer to track 433. The remaining railcars are still on track 431 as the switch has returned to the original position and the remaining cars continue on track 431, bypassing track 432. Railcar 434 has reconnected to railcar 436 and all appropriate connections, including electrical, mechanical, hydraulic, pneumatic, have been reconnected.

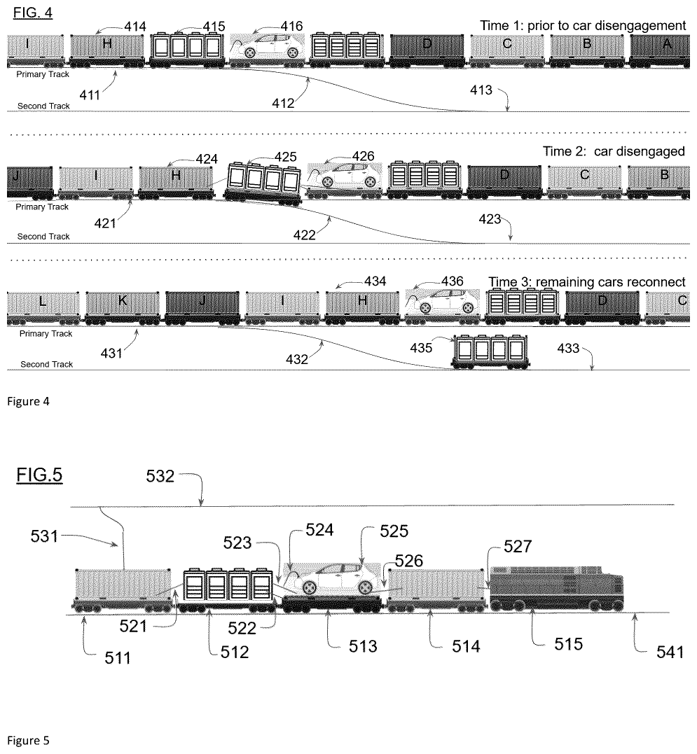

Reference is now to FIG. 5, which shows a variety of different connections between different railcars that can be used to transfer energy between the railcars. These energy connections in a preferred embodiment would primarily consist of electrical connections to conductively transfer energy, but the transfer of energy can also be done wirelessly through inductive or capacitive means, or can be transferred pneumatically, hydraulically or mechanically. Railcar 511 is connected to transfer energy through connection 521 to railcar 512. Railcar 512 is also connected to railcar 513 by energy connection 522. In some embodiments, additional connection 523 can potentially transfer energy from railcar 512 or railcar 513 to a connection 524 to transfer energy to a transported device, in this embodiment shown by electrical vehicle 525. Some embodiments can combine connections 523 and 524 into one device. Connection 526 transfers energy from either device 525 or railcar 513 to railcar 514. Connection 527 transfers energy between railcar 514 and railcar 515, here represented as a device intended primarily or exclusively as a method to generate propulsive power, commonly called a locomotive in the industry. Track 541 can be used for electric energy transfer with the connection circuit being closed longitudinally between contiguous or noncontiguous cars, with the track 541 being separated into different sections being held at separate voltages to transfer energy to the train through, in one embodiment, non-contiguous cars to reduce the chances of inadvertent short circuits. Proximity sensors and location information can be transferred to a control system prior to energy being transferred to the train. Electrical connections can also be provided overhead, here labeled as 532, and transferred to the train inductively, capacitively, or conductively between device 531 and the train of railcars.

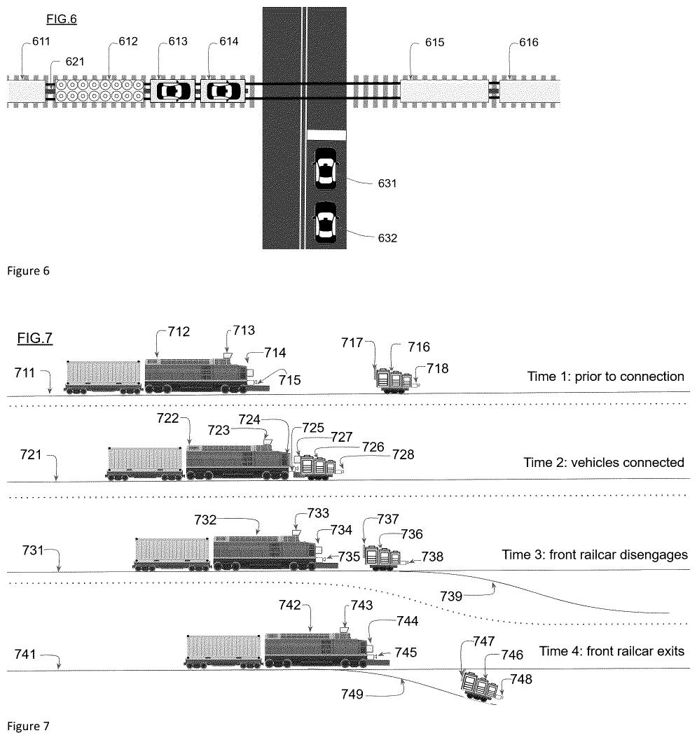

Reference is now to FIG. 6, which shows an overhead view of a railcar, in this embodiment intersecting an at-grade crossing with a public road. Railcars 611 carrying freight, 612 carrying energy storage systems used primarily or substantially to transfer energy to other railcars, 613, and 614 carrying cars with or without passengers inside, being transported to another location, have all stopped to allow automobiles 631 and 632 a chance to pass without large delays. Railcars 615 and 616 have continued on, and may be eventually joined by railcars 611, 612, 613, and 614 and any successive railcars if a management system determines whether it is advantageous for all the railcars to reform into a complete train, or whether it is more advantageous to continue on as two separate trains.

Reference is now to FIG. 7 showing four timesteps, separated by dotted lines, of a train of railcars operating according to one embodiment of this invention.

In the first timestep of FIG. 7, two connected railcars are shown, one of which is lead car 712, on railtrack 711, at time 1, prior to the vehicles being dynamically connected to a second group of one or more cars 716, shown in this embodiment as a single railcar, on the same track. In this embodiment, car 712 is equipped with sensors to detect objects on or near the tracks, such as visual cameras, infrared cameras, distance sensors, laser sensors, or other sensors, and are shown in this embodiments as lidar sensor 713, laser distance sensor 714, used to evaluate rail obstructions and assist in connecting railcars together. A visual camera 715 is also shown on the front of the railcar. Many other sensors and locations are possible. These sensors are detecting the relative positions and velocities of a leading railcar or group of autonomously guided railcars 716, in this embodiment consisting of a railcar that has internal energy storage arranged in a manner such that manual or sensor-based visual evaluation of railcar 712 is not impeded substantially after the two vehicles are connected. Railcar 716 can be equipped with one or more sensors to determine whether obstructions exist and assist in determining the relative positions and velocities of either obstructions or railcars to connect with, in this embodiment shown as visual camera 718 and laser range-finding sensor or reflector 717, but many other sensor types and locations that can assist in determining position, range, velocity, and obstructions and other pertinent information is possible. Sensor and reflector locations between 714 and 717 can be exchanged, and in some cases reflectors may not be necessary at all. Communication between the two sets of railcars and/or a third communication facility not shown assists in connecting the two vehicles without mishap. Sensors can be placed both in the forward and rearward positions on all railcars but in this embodiment all sensors are shown faced in the traveling direction of the vehicles.

In the second timestep of FIG. 7, the same vehicles are shown as in the first timestep, both having traveled further on the common track now labeled 721. At this time 2, one or more railcars shown with previously leading railcar 722 now connected to the previously leading group of railcars with the previously trailing railcar 726. Necessary connections between the railcars, including mechanical, electrical, data, pneumatic, and hydraulic connections among any other connections that are necessary between the railcars. Railcar 726 in this embodiment does not impede the vision of a potential human operator in railcar 723 or some of the sensors in the front of the railcar, including sensors on the tops or sides of railcar 722, in this embodiment shown by sensor 723. Sensor 725 and sensor 727 and reflector 724 may or may not be in use when the vehicles are connected. Information from sensors at 728 can be now transferred wirelessly or through electrical connections to railcar 722 or to other cars or transmitted wirelessly to external locations. In the embodiment shown, energy can be transferred between railcar 726 and 722 as desired.

In the third timestep of FIG. 7, the same vehicles are shown as in the first two timesteps, all having traveled further on the common track now labeled 731. At this time 3, operation is now desired where one or more vehicles 736 disengage from the remaining train including railcar 732. All physical connections are disconnected, with information communicated either between the vehicles or between both vehicles and a third controller located either onboard one of the groups of vehicles or remotely. The two vehicles or sets of vehicles are controlled to operate at different speeds, where vehicle 732 and following railcars are controlled to a lower speed than vehicle or vehicles 736 which are controlled to operate at a higher speed such that the two sets of vehicles separate each other. In the embodiment shown, car 736 is driven autonomously with the help of sensors here shown as 738 and 737, and that operation can be augmented with sensor information transmitted by railcar 732 from sensors 733, 734, and 735. A switch not shown allows the railcar 736 to exit to a second track 739, and then the switch can return to the correct position to allow railcar 732 and following cars to be routed correctly.

In the fourth timestep of FIG. 7, the same vehicles are shown as in the first three timesteps, all having traveled further. The railcar now labeled 742 and following cars continue operating on track 741 and railcar 746 has been routed onto a separate track 749. Sensors 743, 744, and 745 augment the operator or control the operation in autonomous operation of railcar 742, potentially aided by sensors on car 746 and with additional methods to augment distance and location position determination with surface or device 747, here shown as a reflective device to assist with range-finding sensor 744. Sensors on railcar 746, here shown as an optical video as 748, which assists in the operation of the railcar, here shown as fully autonomous.

1. A method of using one or more vehicles controlled autonomously or remotely, with at least one of those vehicles operating primarily or substantially as a means to transfer energy to a second vehicle or group of vehicles that may or may not be autonomous, be controlled remotely, or have driver assistance systems, while all vehicles remain in motion, to ensure adequate or optimal energy supply for operation of the second vehicle or group of vehicles.

2. The method of claim 1, where the energy transfers electrically through a power transfer connection made of some portion of conductive, inductive, magnetic and/or capacitive connections for the purpose of electric energy transfer, transferred between two vehicles to increase the energy available to the vehicle which is receiving that power.

3. The method of claim 2, where the vehicles through which the electrical energy transfers are occurring are vehicles operating on a railroad.

4. The method of claim 2, where the vehicles through which the electrical energy transfers are occurring are vehicles operating on roads, such as automobiles, light duty trucks, medium duty trucks, heavy duty trucks, any one of which could be towing a separate trailer prior to connecting with the vehicle that transfers energy to the first vehicle.

5. The method of claim 2, where the vehicles through which the electrical energy transfers are occurring are vehicles flying, such as airplanes.

6. The method of claim 3, where one group of one or more vehicles is connected with a second group of one or more vehicles at the front of one group of cars and the rear of the other group of vehicles.

7. The method of claim 4, where one group of one or more vehicles is connected with a second group of one or more vehicles at the front of one group of cars and the rear of the other group of vehicles.

8. The method of claim 3, where a first group of two or more vehicles separates into two groups of one or more vehicles, for the purpose of connecting to a second group of vehicles in the between the two groups of vehicles created from the first group of vehicles.

9. The method of claim 1, where one of the two groups of vehicles is controlled remotely from controllers on the second of two groups of vehicles.

10. The method of claim 9, where the control of the second group of vehicles is determined partially or totally by a human pilot.

11. The method of claim 9, where the control of the second group of vehicles is determined partially or totally by algorithms developed to allow autonomous control of the second group of vehicles.

12. A method of optimizing the usage of railroads together with roads, where the segregation of a train may allow for cross-traffic to cross a railroad through the gap created between two groups of cars.

13. The use of vehicles operating autonomously or partially having their speed or direction of travel determined algorithmically by algorithms developed for that purpose, that is used primarily or exclusively for the purpose of transferring energy en-route to other vehicles that can make use of that energy for propulsion, energy storage, or other uses.
